(19) United States
(12) Patent Application Publication
(10) Pub. No.: US 2017/0255907 A1
(43) Pub. Date: Sep. 7, 2017

(54) METHOD AND APPARATUS FOR ENHANCED ONLINE DATING

(71) Applicant: DEEPER DATING, INC., LONG BEACH, NY (US)

(72) Inventors: KENNETH PAGE-ROMER, LONG BEACH, NY (US); GREGORY GEORGE PAGE-ROMER, WESTFIELD, NJ (US)

(73) Assignee: DEEPER DATING, INC., LONG BEACH, NY (US)

(21) Appl. No.: 15/063,426

(22) Filed: Mar. 7, 2016

(51) Int. Cl. G06Q 10/10; G01S 19/13; G06Q 50/00; H04W 4/02; H04L 12/58

(52) U.S. Cl. CPC G06Q 10/1095; H04W 4/02; H04W 4/021; H04L 51/12; G06Q 50/01; G01S 19/13

(57) ABSTRACT

Technological solutions are introduced for providing a secure and effective (hence, enhanced) online dating forum. The ability to attend live events in person or remotely is coupled with presence location and automatic verification of user devices and identities. This allows secured communication between participants without having to disclose actual contact information of the participants or their device addresses.

### CROSS-REFERENCE TO RELATED APPLICATIONS

This application claims priority under 35 U.S.C. §119 to U.S. Provisional Patent Appl. Ser. No. 62/128,987 entitled “ENHANCED ONLINE DATING” filed in the name of Page et al. on Mar. 5, 2015, the entirety of which is incorporated herein by reference.

### TECHNICAL FIELD

This disclosure generally relates to electronic communications, and in particular, it relates to electronic communications involving condition responsive indicating systems.

### BACKGROUND

Even with the absolute explosion of online dating sites and applications in the twenty-first century, the number of single people keeps growing worldwide. For example, in the US, the majority of adults today are unmarried. It's not that people aren't meeting, because online dating has been facilitating countless new meetings and connections. But all these “meetings” aren't turning into lasting love. Part of the reason is in the ways people meet; ways which sculpt shallow, objectifying interactions that are less likely to blossom into relationships. In-person dating events are often cold and dehumanizing, as are online dating sites and apps. Dating algorithms have been shown to be unreliable in making matches. Many recent “dating apps” have social devolved to encourage superficial interactions and “hookups.” Such one-dimensional profile browsing eliminates much of the human element that tends to spark romance. Research shows that one of the key factors in sparking attraction is increasingly vulnerable levels of communication. Online dating may facilitate many connections, but increasingly intimate and vulnerable conversations rarely happen during online dating. Accordingly, there is a need for methods and systems for enhanced online dating, various embodiments of which will now be described in detail herein.

### SUMMARY

Enhanced online dating, sometimes referred to herein as DEEPER DATING, allows for a workshop/lecture/class-like setting for people to meet and interact in many different groupings, seeing each others picture or webcam as they do so, and then bringing them into an online community where they can look at each others profiles and interact with each other through direct messaging, and forums. There will also be associated in-person events, media events, and social media link-ins. DEEPER DATING online events replicate DEEPER DATING in-person events, joining the warmth and excitement of an actual DEEPER DATING event with the ease, comfort and marketing potential of the virtual world.

There are few significant challenges associated with these in-person events, however, that are overcome by the technological improvements of the present disclosure. First, the section in which participants mingle and exchange numbers, although very valuable and not at all impersonal, is extremely challenging. People found this part useful but very stressful. DEEPER DATING online, among its many benefits, creates a layer of safety since it is much easier to approach someone new through a direct message than to do so in person.

Second, in-person events are often harder to attend. Issues of health, weather, ease-of-access and transportation can get in the way of being able to show up in person. DEEPER DATING online allows participants to attend events from the privacy and comfort of their home. All they need is an internet connection.

### BRIEF DESCRIPTION OF THE VARIOUS DRAWINGS

Further aspects of the present disclosure will be more readily appreciated upon review of the detailed description of its various embodiments, provided above, when taken in conjunction with the following Figures, of which:

FIG. 1 is an illustration of a network environment in which the methods and apparatus of the present disclosure may be operative;

FIG. 2 is a representation of a user mobile presence verification process that may be used in the network environment of FIG. 1;

FIG. 3 is a flowchart of a participant interaction process with the network environment of FIG. 1;

FIG. 4 is a screenshot of an enhanced online dating community welcome page presented over the network environment of FIG. 1;

FIG. 5 is a screenshot of an enhanced online dating community registration page presented over the network environment of FIG. 1;

FIG. 6 is a screenshot of an enhanced online dating community profile search page presented over the network environment of FIG. 1; and

FIG. 7 is a screenshot of an enhanced online dating community profile information entry page presented over the network environment of FIG. 1.

### DETAILED DESCRIPTION

Enhanced Online Dating a completely new concept in online meetings joining the warmth and excitement of an actual in-person event like DEEPER DATING with the ease, comfort and marketing potential of the virtual world. It is part personal growth workshop, part cutting edge online meeting, part dating website, and part gathering place for single people with shared interests in an infinite number of arenas.

DEEPER DATING online is an unprecedented new way for single people to meet. The live events are like speed dating but with brains and heart—done from the privacy of a participant's home. In these events, participants will learn some of the most exciting, research-backed insights about finding love, and then meet many new single people through stimulating and enjoyable conversations—all online!

Research shows that dating profile matching algorithms found in dating website of the prior art largely don't really work as a matching tool for finding love. But multiple studies by top researchers in the field of attraction show what does work. These findings are so simple and so time-honored that it is incredible that no one has put them into practice in the creation of endless new dating apps, until now.

Everyone knows that the online dating world may boast countless new possibilities for matches, but that it is anything but warm, positive and engaging. People match better as they get to know each other. The more warm, positive, and engaging interaction, the more chance for a match to occur.

Technology now allows us to offer the infinite numbers of online daters with ways of meeting that are positive, engaging and fun. DEEPER DATING online creates enjoyable, exciting, and positive ways for single people to meet.

We have done trial DEEPER DATING Online events to test the model, and the overall concept works extremely well.

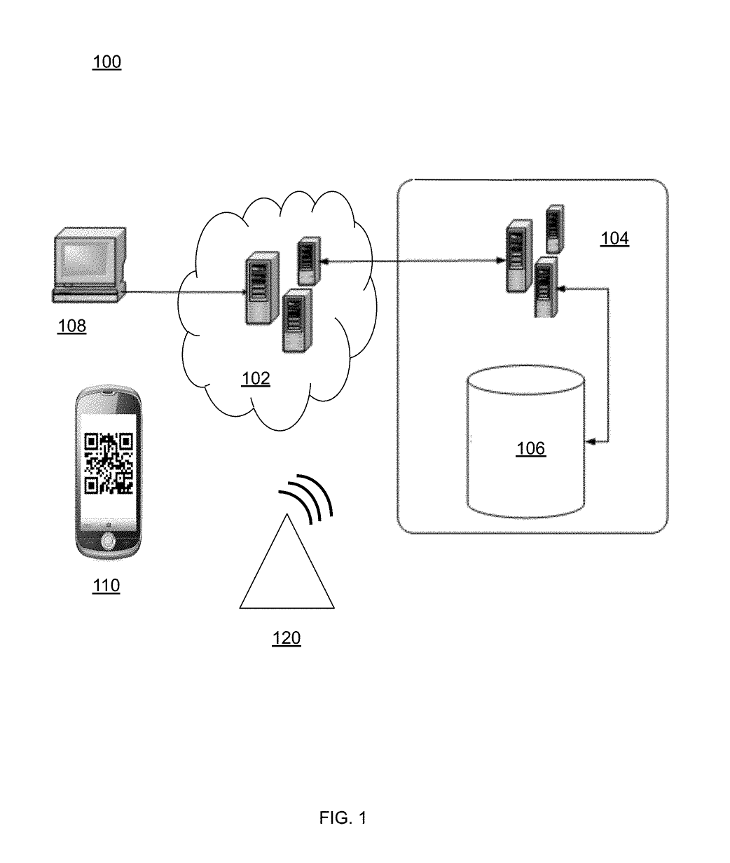

Turning to FIG. 1, therein is depicted an illustration of an exemplary data communication network environment 100 over which user devices may interact with each other and the enhanced online dating website. The enhanced online dating server(s) 104 are the hub of the network environment 100, the special programming of which as described herein enables user computer devices 108 and/or user mobile devices 110 to interact as described herein over a data communication network, such as the Internet. The enhanced online dating server(s) 104 may be one or a group of distributed or centralized network computer servers. Such servers, like any common personal computer, include well-known processors, electronic memory, network communication hardware, user interfaces, input/output devices, operating system software, and application software suitable for accomplishing the functions described herein. A suitable computer server may be one or more enterprise network servers of the type commonly manufactured by CISCO, DELL and IBM. The enhanced online dating server(s) 104 may be configured to perform the functionalities described herein through suitable programming in C++, PHP, JAVASCRIPT or the like, and may include at least one database 106 for storing the data described herein and database management software, for example, similar to the Structured Query Language (SQL)-type databases distributed by ORACLE. The enhanced online dating server(s) 104 may be centrally located or may be distributed among a variety of geographical locations, and may cooperate to enable to social networking functions described herein. The enhanced online dating server(s) 104 may act as a “cloud” service to a plurality of users.

Users will typically maintain an account with the operator of the enhanced online dating server(s) 104. Such account will be registered with the DEEPER DATING system. In addition to user account information, personal profile information and monetary amounts due for subscribing to this service may likewise be stored in database 106.

User terminals 108 may be one or more separate consumer computing devices that are operative to communicate data bi-directionally with the enhanced online dating server(s) 104 over a computer network, such as the Internet. The user terminals 108 may be owned and operated by separate and distinct users. Users may be assigned a login to access the enhanced online dating server(s) 104. When interacting with the enhanced online dating server(s) 104 over the Internet, a display of the user terminal 108 may be changed and updated to enable the customer to directly interact with the enhanced online dating server(s) 104 in the manners described herein.

User terminals 108 may be any suitable computing or communication device used to accomplish the processes described herein. They may be, for example, a personal computer, laptop computer, notebook computer, mobile telephone, smartphone, tablet, personal digital assistant or like device of the type commonly manufactured by IBM CORP, DELL CORP. and APPLE CORP., and having suitable operating system software (i.e., WINDOWS XP, WINDOWS 8, WINDOWS 10, MAC OS X, SUN OS), application software, visual displays, processors, electronic memory, network communication hardware, user interfaces (such as a visible display), and other suitable input/output devices, as are well-known and suitable for accomplishing the functions described herein.

The network environment 100 includes one or more communications interface servers 102, that coordinate communications between user computing devices 108, user mobile devices 110 location determination devices 120 and the enhanced online dating server(s) 104. In certain embodiments, the network environment 100 is implemented over a publicly-accessible computer network, such as the Internet or World Wide Web, via network interface servers 102, which may be any type of server mentioned above. The disclosure is not limited to implementation in any specific network configuration. The location determination devices 120 are readily contemplated to include the use of any wireless and/or hard-wired devices operating in conjunction with satellite, microwave, fiber optic, copper, local area networks (LANs), wide-are networks (WANs), WIFI, IEEE 802.11-based protocols, WIMAX and/or other network configurations. The location determination devices may likewise include Bluetooth or WI-FI beacons, GPS geo-fencing systems, near-field proximity detectors, radio-frequency identification (RFID) tags or the like. In certain embodiments, the location determination devices 120 may be a display of a barcode or other machine-readable indicia that ay be scanned by a user mobile device 110, the scanning of which will confirm a user's presence at a location.

The network environment 100 may be implemented in any type of system comprising interconnected computers configured to communicate data with each other using messages transmitted electronically or via other means, without limitation. Data may be transmitted between the computers, devices and servers shown in FIG. 1 using any of the variety of data formats including, but not limited to, Hypertext Transfer Protocol (HTTP), file transfer protocol (FTP), or any other suitable data transmission protocols. Data transmissions may also be encrypted with any of a variety of known technologies, including secure socket layer (SSL) topologies.

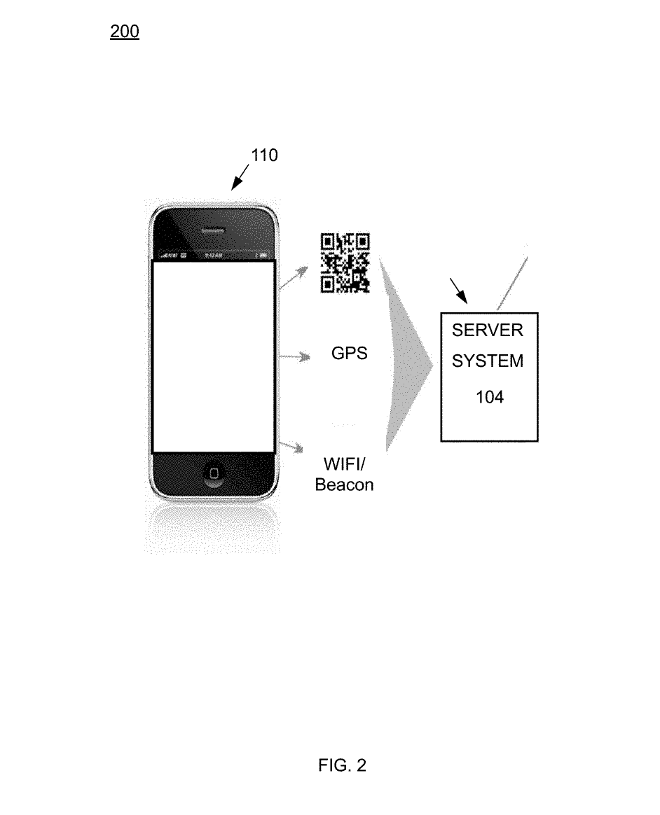

As depicted in FIG. 2, a user may use a wireless communication device such as user mobile device 110, which may be a cellular telephone having an imaging device, such as a still or video camera. The user mobile device 110 may also include an interface, such as a browser application, for accessing the Internet or other computer network. Examples of such web browsers include SAFARI, INTERNET EXPLORER and FIREFOX. The user mobile device 110 may also include appropriate native hardware and software to send and receive SMS or text messages, and electronic mail messages. Messages transmission may be facilitated by the DEEPER DATING website in such manner that participants can communicate with each other without having to disclose telephone number of the user's mobile device 110 or the actual e-mail address of a user. A proprietary application may optionally be provided on the user mobile device 110 to perform the scanning and/or web interface functions described herein. The wireless device 20 may additionally include appropriate hardware and software for interacting with a global positioning system (GPS), such that the user mobile device 110 may determine its geographic location. Additionally, the user mobile device 110 may include any of a variety of software applications for imaging and decoding a code or symbol, such as a QR code. Examples of such code-reading applications include NEOREADER, MOBILETAG and CODE READER. Examples of cellular telephones on the market today that are equipped with the features above include the IPHONE, BLACKBERRY, and ANDROID smartphones.

The user mobile device 110 is operable to communicate bi-directionally with a computer server system 104 over any of a variety of communications networks, via a wireless communication 200 which may include Wi-Fi, GPS, SMS, cellular or other types of data transmissions. Such communications networks may include a cellular telephone network, a cellular data network and a wireless computer network of the type operated by VERIZON and AT&T. The communication network may provide access to any variety of hard-wired or wireless computer networks now known or heretofore developed, including, without limitation, local area networks, wide area networks, fiber optic networks, satellite communication networks, as well as the World Wide Web.

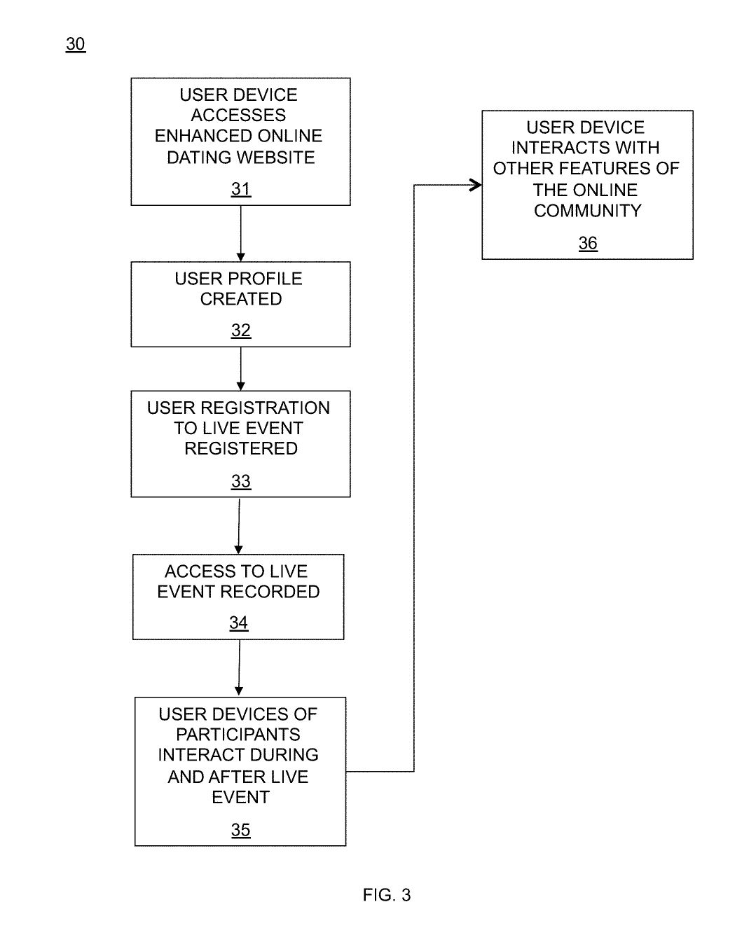

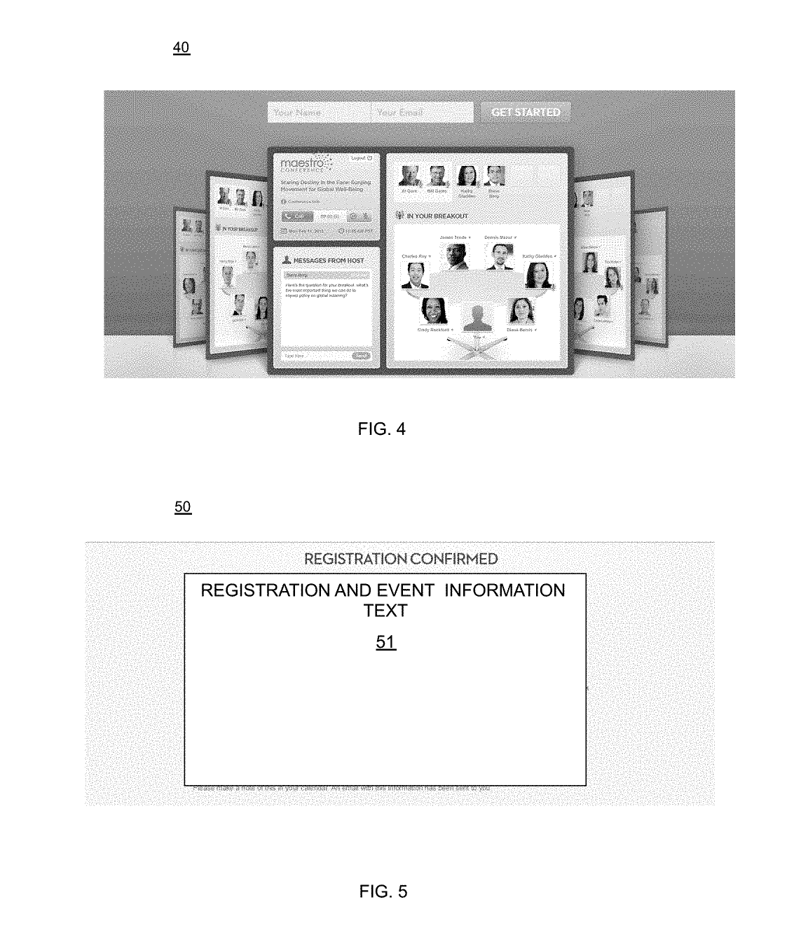

Turning now to FIG. 3, therein is presented a participant interaction process 30 with the network environment 100. The process 30 commences at step 31, where users visit to the DEEPER DATING website, where they can learn about upcoming live dating events event and register for such events to attend remotely or in-person. The website, an example of the display of which is sown in FIG. 4, includes a description of what differentiates us from other programs and services for single people; what makes us unique, exciting, inspiring, and why this approach represents a new model of looking for love. It may point out shortcomings of other dating events and describe why this method works better, mentioning how this is based not upon profile matching algorithms, flat profiles, or limited, demeaning ways of meeting, but based instead upon the very values that lead people to bond: shared values, shared interests, and engaging on a human scale with real interaction.

The DEEPER DATING website may further include a welcome video explaining this new approach, and congratulating them on becoming part of a whole new way to meet. This video would have extras such as graphics, animation, video clips from top experts, and the like describing how DEEPER DATING integrates both cutting edge research, and the power of technology to create real-life positive ways of engaging—right from your own home.

The DEEPER DATING website may further include endorsements from famous people or thought leaders.

The content of the DEEPER DATING website may be filtered by a visiting user's location: (city, state) and personal interests. For example, there could be many buttons with different interests, such as Theatre, Education/learning, Personal Growth and Human Potential, Travel, Art, Service to Others, Living Green, Exercise, etc. Users can select their top choices via selection of such buttons, and their preferences will be stored in database 106 and automatically added to their profile.

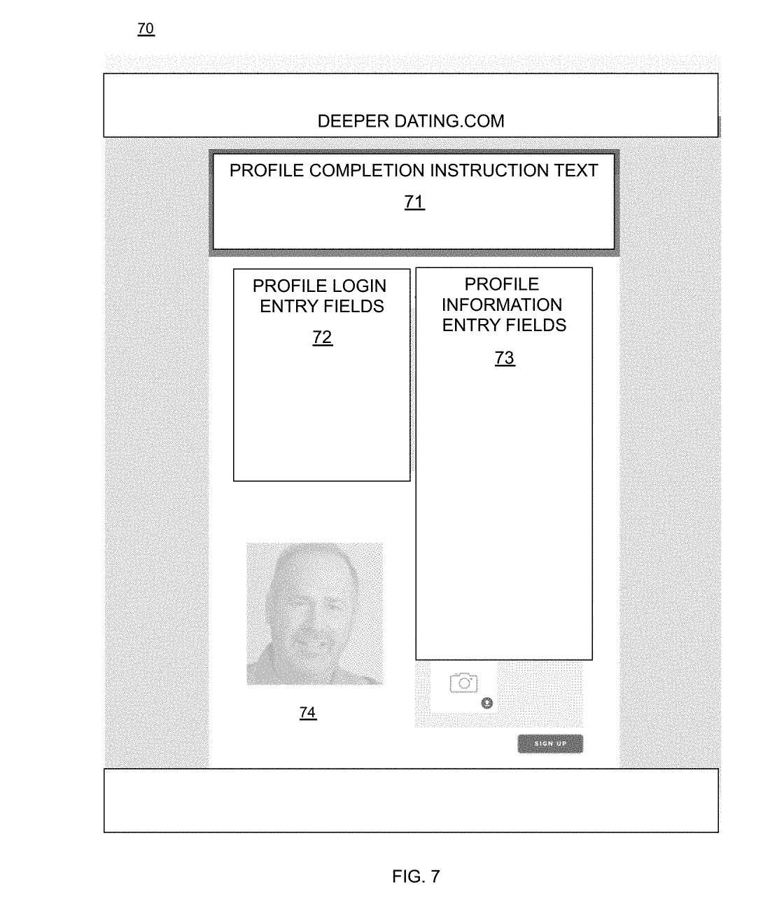

Turning now to step 32, users next register and create a profile. FIG. 7 shows an example of a registration page 70.

Turning now to step 33, users may sign up for and pay admission to an upcoming live event. For events generated by DEEPER DATING, registration and payment would happen on the DEEPER DATING website.

Participants must also register with the platform in which the event will be simulcast on the Internet, such as on the existing service MAESTROCONFERENCE. Users will first be sent a link with which to register for the actual online meeting event, an example of which is as follows:

maestroconference.com/conference/register/9P8QJOAPWGMIZLF4

When users register for an upcoming event, they get the details they need to register: their own URL, phone number and password. At some point before the actual event, participants also need to upload their picture; the same picture they used in their profile. When a user is registered, they may receive a display of a registration confirmation screen 50 as shown in FIG. 5.

Turning now to step 34, the event begins with a presenter giving a talk, welcoming everyone and offering some insights and ideas. The talk is engaging and interactive, and presenters will call on users who have questions or virtually “raise their hands” and answer some questions and give a kind of pep talk. In the future, there may also be opening videos, powerpoint presentations, screensharing, etc as part of the beginning of an event. There may also be an author/thought leader/speaker who gives a talk on a particular subject.

Each event begins with an approximately ten-minute talk on the DEEPER DATING approach to finding love. Users then are broken into a series of breakout groups, and sometimes will be broken into pairs of two. The groups may be of different sizes. In groups, there mayl be equal numbers of men and women for opposite sex events and same sex groups for same-sex events. In opposite sex events pairs will be male-female, in gay/lesbian groups they will be same sex pairings. In these groups, they are given emotionally positive, engaging, fun questions for each participant to answer, questions that let them show their best selves, such as: “Tell about a favorite relative of yours as you grew up. Talk about a pet you loved. Tell about someone who has been a hero for you in your life.” The question appears in a text box so all participants can refer to it. The questions will often relate to the talk that was given.

In each breakout group, participants get to see photos and/or live videos of each member of the breakout group. Platforms such as MAESTROCONFERENCE allow us to break the participants into random groups, allow participants to self-select into groups and allow us to create customized breakouts through polling. FIG. 4 shows an example of what a breakout group looks like on MAESTROCONFERENCE.

In between breakout groups, the organizer will sometimes pull everyone into a large group and have some interaction with them/ask for questions etc. This adds variety and gets people “up front” for everyone to see. There can also be powerpoint presentations, screen-sharing, and shared web-browsing. In the large (full) group, people get to see photos or videos of everyone who “comes to the stage” with a question or comment.

There will be all kinds of interactions in and out of breakout groups, including shared activities, self-chosen breakout groups, mingling, and more. There will be an application where participants can write themselves personal notes matched to each participants profile so they remember who they are and who they are interested in. There will be applications which allow participants to rate, evaluate and make notes on participants of interest which will follow them throughout the event and after to help them to decide whom to contact after the event. Such preferences may be stored in database 106 along with their profile information.

In some events that are less structured and include more mingling, participants will exchange contact-information during the event.

Each event will have a closing where people can share their thoughts and experiences in the main room, in front of everyone. These sections of the events are inspiring and usually people have lots of comments.

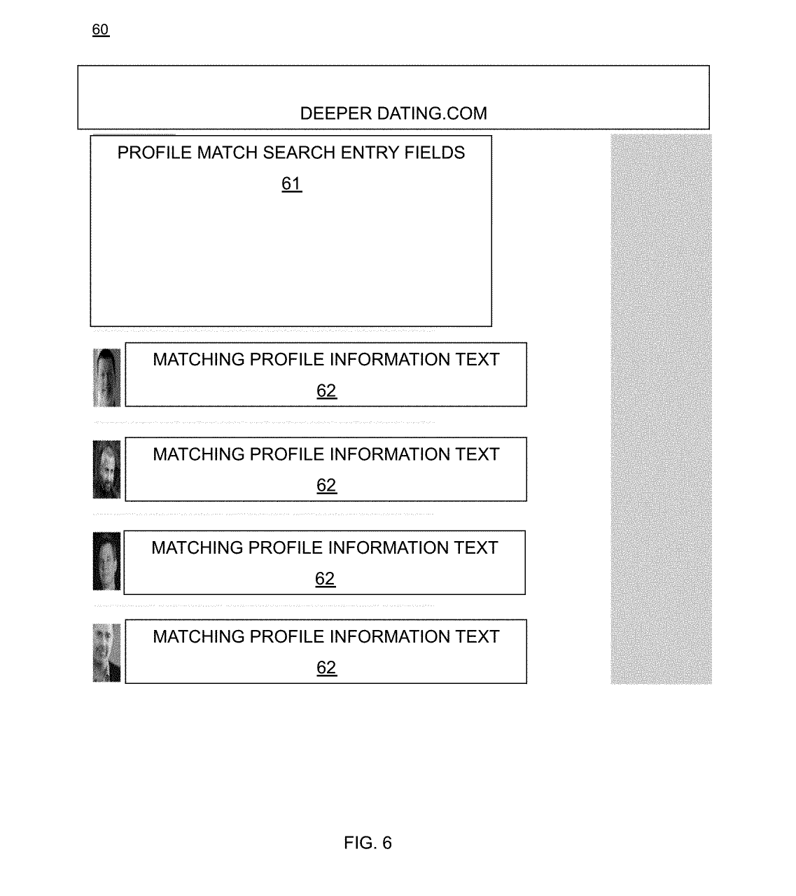

Turning now to step 35, after the conclusion of a live event, participants are encouraged to interact with other event participants via the DEEPER DATING online community. After the event, participants can go to a special section on the DEEPER DATING website where they will see all the members of their group and their profiles. Participants can learn more about them through their pictures and profiles, and they can interact through a safe direct-message type of format. FIG. 6 present an example of profiles of participants that attend the live event remotely or in-person.

Participants will be able to read each others profiles, take part in forums in this group, and also direct-message each other to connect and hopefully meet when it seems like a match. Additionally, they will be able to connect to more information about DEEPER DATING orgranizers, and the work and books of the speaker in the live events.

Turning now to step 36, users may then interact with other features of the DEEPER DATING online community. There will also be premium subscriptions where users would be able to see and interact with all the people's profiles on the site, not just the ones who attended their event. Literature including books by the dating experts who speak in the live events will be available online, as well as opportunities to learn of other resources and join mailing lists on the subject.

In addition, there would be a library of all of the videos of lectures given in live events, and chat room type discussions around each video. This library will be a curated growing body of video and audio talks. Partnerships will be developed with various institutions and there would be a “hall” or section for each. For example, there would be publisher-specific sections, where all the talks by authors and speakers affiliated with a given institution would be housed, with cross-postings as needed. These talks would be used in DEEPER DATING online events in various locations (for example, an author of a new cookbook gives a talk on Chinese cooking, and this talk is used for a DEEPER DATING event in Tucson for single people who love to cook.)

Even if people didn't attend an event, they could see the videos, and could create forums for discussion around these topics which other members can comment on, and then meet that way as well.

There would also be a library of talks around dating and finding love for people who want to learn about my approach in a deeper way. There are provided chatrooms dedicated to these topics as well.

There will be a great synergy with the speakers too. They will get their books sold, and build their fan base, since these are people who elected to explore their area of expertise. These events will effectively be discussion groups on authors works. These authors would also publicize the event to their fan base including social media, such as TWITTER and FACEBOOK. These online events could be connected to online retailer booksellers, such as AMAZON. Links to buy the author's book may be provided and the operator of the DEEPER DATING website may receive a share of sales from selling of the book.

There are many other content areas on the DEEPER DATING website. For example, there may be a TWITTER-like section entitled “What are you doing now?” As with TWITTER, users may provide a short status message concerning their current activities. For example: “I'm about to go on a blind date. This guy sounds great on paper. Any suggestions?” “Second date. Guy cute. Want to kiss. His breath atrocious! What do I do?” “I think I really like this woman. Feeling insecure. Romantic dinner. Really want to enjoy her gifts, lead with mine.”

Another section of the DEEPER DATING website may include a series of meditations and inspirational talks from speakers for every facet of dating: Before a first date, Going online to look, A Party, Making weekend plans, Sexual authenticity, Sexually-transmitted disease awareness, and Breaking up.

An additional section of the DEEPER DATING website may include moderated chat rooms, on a number of different subjects.

An additional section of the DEEPER DATING website may include DEEPER DATING wallpaper post-its that users can write or are written for them, that appear on user's display screens when they go online. One of those post-its is a list of the four guiding insights around online dating, one has a link to an upcoming YOUTUBE meditation to be done whenever users are about to go online to look for love.

An additional section of the DEEPER DATING website may include a MY DEEPER DATING DIARY to record personal thoughts and daily activities.

An additional section of the DEEPER DATING website may include User-generated content, focusing on a wide range of themes related to the DEEPER DATING approach but also to all the other content on the site. Curated comments from users about their work with each step. Every week, a selected user comment may be featured on the homepage presented to all users.

An additional section of the DEEPER DATING website may include a coaching section, with blogposts from DEEPER DATING coaches. Online coaching, SKYPE coaching, phone coaching, and in-person coaching opportunities are made available

An additional section of the DEEPER DATING website may include advertising opportunities by sponsors will be possible at many junctures.

The technical implementation of the Enhanced Online Dating disclosed herein may include three main sections: the website, the social community, and the online dating events. For this solution to provide the best user experience possible, there must be seamless integration between all three of these sections. There is currently no solution in the market that provides all of this functionality.

The DEEPER DATING Website provides information about DEEPER DATING live or online events, including: information about its creator Ken Page, a landing page for his DEEPER DATING book, a DEEPER DATING Online page, which currently includes a place to sign up for events, a description of DEEPER DATING events and the past history, a section to sign up for the latest upcoming event, additional information will be added on this page, such as YouTube videos, FAQs, etc.

The current DEEPER DATING website is built using WORDPRESS technology. Currently, we are using BUDDYPRESS and WORDPRESS to house our online community and we are using MAESTROCONFERENCE's social webinar (www.maestroconference.com) as our platform to allow an online event with breakout groups and participant pictures. DEEPER DATING may use another more sophisticated program for the online community in the future, and other online meeting platforms that also offer this cutting edge technology, such as ILINC, NEW ROW and SHINDIG. The Enhanced Online Dating model is not limited to the use of a specific technology platform.

One of the most important parts of the Enhanced Online Dating Platform is the ability for participants of DEEPER DATING Online events to find and communicate with each other after the event. To provide this functionality, we started with BUDDYPRESS (an add on to WORDPRESS for social communities). Registration allows people to register on the website. When a user registers on BUDDYPRESS/WORDPRESS, they should receive a confirmation email to verify their registration. They will need to click on the verification link before they can enter the site. Sometimes, these verification emails don't get sent to the registered users so they cannot log onto the site. Several ways around this issue are to: (1) Force them from Pending Registration to Active Users (this is an option for BUDDYPRESS/WORDPRESS administrators); (2) Don't require verification (there is an option to override the need for verification. Once a user registers, they can immediately start using the social community features of the website. The only issue is that unwanted users might be able to register); (3) Use SMS or other ways to verify registration (An SMS verification might provide the best overall solution to prevent unwanted users from creating accounts, yet not holding up the overall registration experience. We have the ability to redirect to a web page after registration so any of these options can be easily integrated into the solution) (4) Logon to the DEEPER DATING Website (This allows for users to log onto the site to use the social community features. The BUDDYPRESS/WORDPRESS login process also allows for resetting passwords, etc.); (5) Creating/Editing Profiles (One of the key features of dating sites is the ability to find matches based on profiles. We modify the BUDDYPRESS look and feel and text in this area to make it more user friendly and aligned to our needs, including combining the Registration and Profile creation steps and pages.

Initially, the user's required profile is kept simple to make the process quicker and easier for participants. Currently, participants are only asked to enter the following required fields (but we will be adding more in the future, such as Interests): First Name, Gender (including ‘Other’), Interested in (including ‘Other’), State (to assist with locating other users in your area), Self-Description (we also explain what this means during the process to help users enter the right information, Picture. An example of a profile generated in this manor is depicted in FIG. 7.

Groups are key to the Enhanced Online Dating Platform since they are the place that is used to tie together the participants and forums (live or online)for each specific DEEPER DATING event. For each event, a group is created and all members that are registered for that event are added to the group. Members can be in multiple groups at the same time. Eventually, a premium subscription will allow members to see all other groups and be seen by members in other groups.

Participants are the users that are registered on the site for a live or online dating event. Each participant has an enhanced DEEPER DATING Profile that other participants will use to find and communicate with each other. For each event, a group is created and all participants that are registered for that event are added to the group. Participants can be in multiple groups at the same time. A premium subscription will allow members to see all other groups and be seen by members in other groups.

Forums allow members in a group to communicate with each other. For each event, a group is created and all members that are registered for that event are added to the group. Each group has a forum. In the Forum, members can post a message for others to respond to for all in the group to see. This is different than personal messaging where only the two members messaging see the messages. This functionality is currently available in BUDDYPRESS/WORDPRESS but is upgraded to provide a better look and feel.

Messaging allows members in a group to communicate with each other on an individual basis for only them to see. For each event, a group is created and all members that are registered for that event are added to the group. Members will be able to see a list of all members in their group and will be able to search on them. This functionality is currently available in BUDDYPRESS/WORDPRESS but it will need some work to provide a better look and feel. This functionality will eventually be replaced by our new integrated platform.

The last part of the Enhanced Online Dating Platform is the ability for participants of DEEPER DATING Online events to participate in the live event. During these events, members will need to be able to see and hear the other members in the event. This can be done via pictures with teleconferencing and/or webcams. Other functionality that is needed, includes: Polling, Breakout groups, Public announcements (including into breakout groups), Screen-sharing, White-boarding, and Embedding the meeting into our website.

To provide this functionality, we reviewed several of the top contenders, including: SHINDIG, MAESTROCONFERENCE, ILINC, and NEW ROW. Currently, even though each of them meets our basic requirements listed above, none of these solutions is perfect. We chose not to rely on one particular meeting platform since each one has its own benefits and drawbacks, and this field is constantly changing and expanding. Instead, we will use best-of-breed technology and will be able to easily swap out the online meeting event technology and fully integrate it into our new platform.

### 1. MAESTROCONFERENCE:

a. Seems to be the only service that currently allows:
   i. Public announcements into each breakout group by the presenter(s)
   ii. Telephone connection at affordable rates (common long-distance charges as opposed to VoIP which can create awkward time lags, especially for dating events
b. Current issues to overcome:
   i. Requires that participants post their picture when they are actually signing on to the event, instead of allowing this to be done prior to the event and their process of accepting pictures is somewhat finicky. There are several workarounds for this:
      1. Based upon our request, they are trying to allow this process to occur in advance of the event.
      2. We will tell people that they should use a picture from Facebook since it should be the correct size, etc. and if they still have problems uploading their pictures, that we will do it for them.
   ii. They also have issues with dropped calls and the process that they are working through.
   iii. MAESTROCONFERENCE does not yet easily allow participants to show themselves on webcams.

### 2. NEW ROW/ILINC/SHINDIG:

a. Advantages of using these newer web conferencing technologies:
   i. Utilize webcams as well as pictures for those that don't have webcams
   ii. You can preregister for the event to make it easier to manage pictures.
b. Current issues to overcome:
   i. Sometime VoIP provides an unacceptable delay. They will allow us to purchase an integrated voice bridge which is a very workable solution on a tech level, but the cost is high, making it less of a favorable choice.
      ii. The don't allow public announcements while in breakout rooms but we can install an MP3 with announcements about time left, etc.
      iii. NEWROW requires members to post their picture each time they enter a breakout room, which is very cumbersome.
      iv. Shindig does not allow pictures, only videos, and videos are not always flattering, and harder to manage. They are now trying to accommodate us by adding the option of a JPG instead of a video.

FIG. 4 is a screenshot of an enhanced online dating community welcome page 40 presented over the network environment of FIG. 1.

FIG. 5 is a screenshot of an enhanced online dating community registration page 50 presented over the network environment of FIG. 1. Registration, confirmation and event information text 51 may be presented to a user via this page 50.

FIG. 6 is a screenshot of an enhanced online dating community profile search page 60 presented over the network environment of FIG. 1. Profile match search entry fields 61 may be presented on a display of the user's device to enter search requirements for profiles of other users. Users that participated in the same online or live dating event may also be provided on this page 60. Matching profile information text 62 may likewise be presented on this page 60.

FIG. 7 is a screenshot of an enhanced online dating community profile information entry page 70 presented over the network environment of FIG. 1. This page 70 may include profile completion instruction text 71, profile login entry fields 72 (such as username and password), profile information entry fields 73 and a profile picture 74. All the information from these fields may be stored in database 106 for each user and participant.

Various of the algorithms described involve the communication of data between devices. Any of a plurality of known communications protocols may be employed to accomplished these specially-programmed functions. An example of an HTTP protocol data communication request for data is as follows:

var http=require(‘http’);

var options={host: ‘www.deeperdating.com’, path: ‘/integers/?num=1&min=1&max=10&col=1&base=10&format=plain&rnd=new’};

callback=function(response)

var str=“login_id”;

response.on(‘data’, function (check) {str+=check;});

http.request(options, callback).end( );

Various of the embodiments disclosed herein require the recall of stored data from a database or memory. Any of a variety of data protocols may be used to accomplish these functions. An example of a SQL database query is as follows:

SELECT PARTICIPANT_ID, LAST_NAME

FROM PARTICIPANT_TBL

WHERE CITY=‘MANHATTAN’

ORDER BY PARTICIPANT_ID;

Although the best methodologies have been particularly described in the foregoing disclosure, it is to be understood that such descriptions have been provided for purposes of illustration only, and that other variations both in form and in detail can be made thereupon by those skilled in the art without departing from the spirit and scope thereof, which is defined first and foremost by the appended claims.

What is claimed is:

1. A method for enhancing online dating, comprising:
receiving, from a mobile device of a first user, a first registration of a first user to attend a dating event in-person;
receiving, from a computing device of a second user, a second registration of the second user to attend the dating event remotely;
after commencement of the event, assigning the first user and the second user to a dating group;
confirming that a location of the first user matches a location of the live event using at least one of: a GPS signal from the user mobile device and a scan of a machine-readable indicia presented at the location of the live event by the user mobile device; and
allowing the mobile device to exchange messages with the computing device based on the first registration and the second registration, wherein a telephone number of the mobile device is not displayed to the second user and a device identification of the computing device is not presented to the first user.
